(19) United States
(12) Patent Application Publication
(10) Pub. No.: US 2011/0091618 A1
(43) Pub. Date: Apr. 21, 2011

(54) METHOD FOR PREVENTING OXIDATION AND OFF FLAVORS IN HIGH CAROTENOID FOODS

(75) Inventor: Laixin WANG, Plano, TX (US)

(73) Assignee: FRITO-LAY NORTH AMERICA, INC., Plano, TX (US)

(21) Appl. No.: 12/580,728

(22) Filed: Oct. 16, 2009

(51) Int. Cl. A23L 1/272

(52) U.S. Cl. 426/267

(57) ABSTRACT

Disclosed is a method for preserving and enhancing the shelf-life of dried foods having relatively high levels of carotenoids. The method uses calcium ascorbate to prevent the oxidation of carotenoids and the polyunsaturated fatty acids. The process can be used to make treated dry food ingredients such as carrot pomace powder that can be later rehydrated and used to make carotenoid rich doughs, which can be further formed by extruding, sheeting or other forming means and cut into pre-forms and thermally processed into ready to eat shelf stable snack foods. The process can also be used to enhance the shelf-life of carotenoid-rich thermally processed snack foods made from raw food ingredients such as sliced carrots.

### BACKGROUND OF THE INVENTION

1. Technical Field

The present invention relates to a method for preventing the oxidation and off flavors of high carotenoid foods.

2. Description of the Related Art

Color and flavor are two sensory properties the consumers look for in snack foods. Many of the natural compounds that produce desirable colors in foods are also nutritionally beneficial. For example, the relative amounts of different carotenoids are related to the characteristic color of some fruits and vegetables. Carotenoids are desirable in foods for their nutritional value. For example, beta carotene is a precursor of vitamin A and retinin. Carrots are an example of a natural food that is rich in carotenoids and would therefore be an ideal ingredient for making a snack food having natural colors and flavors.

Shelf stable snack foods are typically made shelf stable by lowering the moisture content to below about 3% by weight in the case of ready to eat snack foods to provide shelf stability. Similarly, raw food ingredients can be made into dried powders or flours that can be later rehydrated and used as ingredients for making a dough. Such dried powders or flours are typically dried to shelf stable moisture contents of between about 6% and about 15% by weight.

Unfortunately, the stability of carotenoids in dehydrated foods and dehydrated food ingredients is poor. Because of the highly unsaturated nature of carotenoids, they are highly susceptible to oxidation in such dehydrated foods. Such instability is demonstrated by dehydrated carrots whose rapidly fading color following dehydration is a visual indication of the degradation of the color-bearing carotenoids that occurs by oxidation. Such oxidation also promotes off-flavor development in foods. Further, the oxidation and off-flavor development is accelerated in fried carrot chips (and other carotenoid-rich foods) due to the co-oxidation of fatty acids and carotenoids.

As part of the consumer's continual desire to gravitate towards foods having more natural ingredients, there is a need for manufactured food products that use natural food ingredients to provide the desired colors and flavors. Consequently, a need exists for a method for making snack foods and snack foods ingredients that are shelf-stable and less susceptible to oxidation than presently available.

### SUMMARY OF THE INVENTION

One aspect of the present invention is directed towards a method for extending the shelf life of a low moisture food having relatively high levels of carotenoids comprising the steps of providing a raw non-enzymatic browning food having a carotenoid concentration of at least about 20 ppm, adding calcium ascorbate to the food so the food comprises at least about 0.1% by weight of calcium ascorbate prior to dehydration and dehydrating the food to a shelf-stable moisture content of less than about 15% by weight.

In one aspect, the present invention is directed towards making a shelf-stable dehydrated carrot powder from carrot pomace. In one aspect, the present invention is related to making a vacuum fried food product from a raw non-enzymatic browning food having a carotenoid concentration of at least about 20 ppm having greater shelf-life than available in the prior art. In one aspect, the present invention is directed towards making a shelf-stable vacuum fried carrot pieces. The above as well as additional features and advantages of the present invention will become apparent in the following written detailed description.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a general flowchart of a method for the prevention of the oxidation and subsequent off flavors in a powder made from carrot pomace in accordance with one embodiment of the present invention;

FIG. 2 depicts a general flowchart of a method for the prevention of the oxidation of carotenoids and subsequent off flavors in a fried food having a high carotenoid content; and

FIG. 3 depicts a chart comparing the hexanal concentrations of various treated and untreated vacuum fried carrot chips in accordance with one embodiment of the present invention.

### DETAILED DESCRIPTION

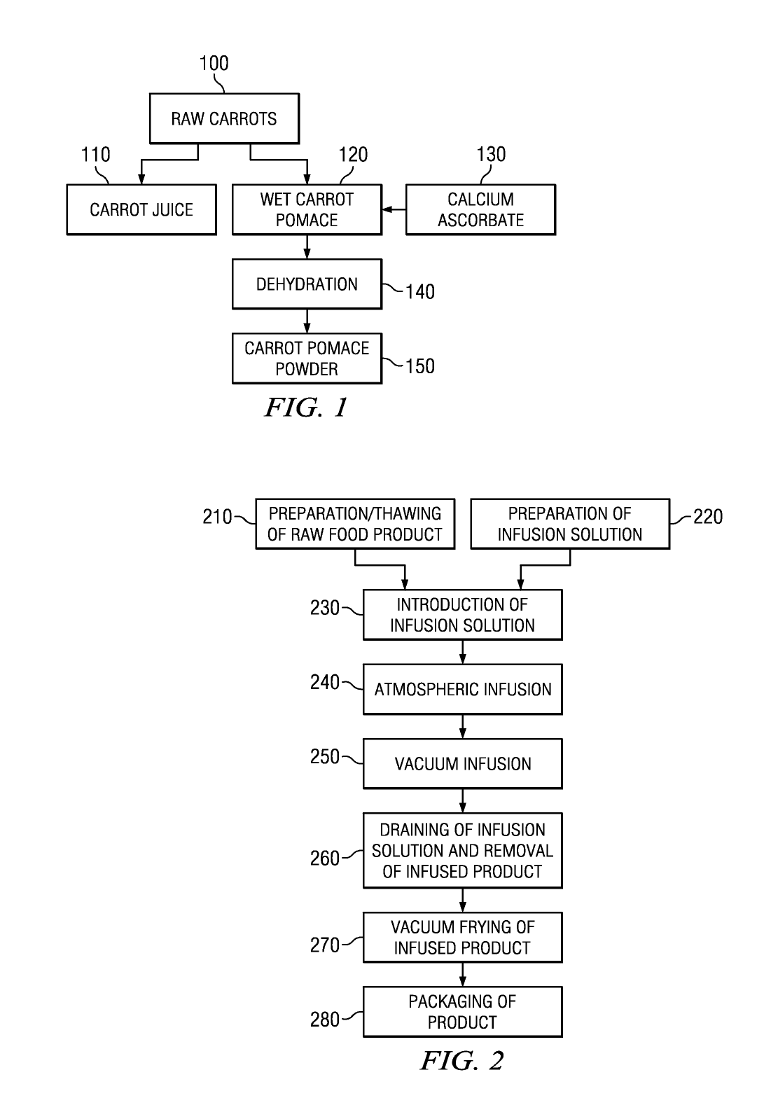

FIG. 1 depicts a general flowchart of a method for the prevention of the oxidation and subsequent off flavors in a powder made from carrot pomace in accordance with one embodiment of the present invention. As shown in FIG. 1, carrot pomace 120 is a by product in the production of carrot juice 110 from raw carrots 100. Because the carrot pomace powder contains less sugar and in particular less reducing sugar than is found in conventional carrot powder, the powder made from a carrot pomace 120 has both processing and nutritional advantages over regular carrot powder. Lower sugar levels lead to less browning from Maillard reactions upon thermal treatment. Further, carrot pomace contains about 52% of dietary fiber which is higher than conventional carrot powder.

As discussed above, food ingredients such as carrot pomace 120 are typically dried to eliminate any spoilage or pathogenic organisms and to inactivate various enzymes in the food product. Such drying can soften the cell walls and destroy the cellular membranes. Consequently, upon drying or dehydration, the protection of the native environment is lost and the carotenoids are readily oxidized—especially if the product is exposed to air and light.

Because carotenoids are highly unsaturated, the oxidation is much more rapid in dry foods than in their native water-rich environment—even if the dry foods are at ambient temperature or under refrigerated storage. Thus, carotenoids, which are normally stable within the original cellular structure, if exposed during drying or dehydration to the external environment, can be easily oxidized when subject to light and atmospheric oxygen.

Surprisingly, the addition of calcium ascorbate 130 to the carrot pomace 120 prior to dehydration 140 by oven drying or other suitable drying methods including, but not limited to infrared or microwave drying, substantially reduces the oxidation of the beta carotene and other carotenoids in the carrot pomace 120. Without being limited to theory, it is believed that the calcium ions form a gel with the pectin within the cellular material and thereby prevent the oxygen penetration that can oxidize the carotenoid. Pectin substances are located in the middle lamellae of plant cell walls and function in the movement of water and as a cementing material for the cellular network. When pectin substances are heated in an acidified water-rich medium, the pectic substances are hydrolyzed to form pectin. A similar reaction occurs during the ripening of the fruit and vegetables. The level of pectin found, for example, in native raw carrot tissue is about 10% by weight. It is believed that the calcium ions from the calcium ascorbate can act as a bridge between neighboring pectin molecules within the carrot tissue and such bridging prevents the penetration of oxidizing substances, such as oxygen free radicals.

Further, the resultant ascorbic acid and its esterified derivatives may also function as oxygen free radical scavengers and can, therefore, protect against oxidizing agents thereby further minimizing the potential of oxidation of the carotenoids. Consequently, in one embodiment, the wet carrot pomace is treated by adding a sufficient amount of calcium ascorbate. In one embodiment, a sufficient amount occurs when the wet carrot pomace compresses at least about 0.1% by weight of calcium ascorbate, and in one embodiment between about 0.2% and about 0.3% by weight. When the treated wet carrot pomace is dried, the resultant treated dried carrot pomace has lower levels of undesirable oxidation than untreated dried carrot pomace.

In one embodiment, the carrot pomace is dehydrated at a temperature of between about 50° C. and about 60° C. for between about 8 hours and about 12 hours minutes to a moisture content of less than about 15% by weight and, in one embodiment, between about 6% and about 15% by weight. A carrot pomace comprising about 85% water by weight will result in a dehydrated food product comprising at least about 0.67% calcium ascorbate by weight on a dry basis. While the above process has been described with respect to carrot pomace, the process can be used for any desired food ingredient having elevated levels of carotenoids (e.g., levels above about 20 ppm) or other desirable polyunsaturated fatty acids that are susceptible to oxidation. Examples of such foods can be found in Table 1 below. In one embodiment, at least about 0.1% of calcium ascorbate and between about 0.2% and about 0.3% by weight of calcium ascorbate is added to a food puree or pulp from a food listed in Table 1.

FIG. 2 depicts a general flowchart of a method for prevention the oxidation and off flavors in a fried food having desirable levels of polyunsaturated fatty acids such as carotenoids in accordance with one embodiment of the present invention. Raw product, including fresh or frozen fruit and vegetable products, is processed 210 prior to transfer to a mixing apparatus, such transfer occurring by any means known in the art, such as a conveyor, or even manually. As used herein “frozen” refers to a product which is at least partially frozen or comprises at least some frozen moisture. Thus, the term encompasses product which is either partially or fully frozen. In some embodiments the partially frozen product comprises individually quick frozen (IQF) product. While the embodiments described refer generally to IQF product, it should be noted that the invention is not so limited as it applies to any frozen product. As used herein the terms “IQF product” shall refer to any fruit or vegetable product which is stored as an IQF product and can be infused. IQF product can have a temperature from about −10° F. to less than about 32° F. (0° C.), but they are typically kept at temperatures of about −10° F. (−23° C.) to about 10° F. (−12° C.).

The processing of step 210 may include washing, coring, pitting, cutting, slicing, thawing, and other steps prior to infusion as required by the specific product. Consequently, the processing 210 of the food products will differ depending on the fruit or vegetable chosen. The size of the batch of product processed depends on the size of the mixing apparatus, the size of the infused product batch desired, and the desired ratio of product to infusion solution. In a preferred embodiment, the ratio of product to infusion solution is 1:3.

As an example of the processing step 210, in one embodiment of the present invention, raw products such as raw carrots are processed for infusion. The raw carrots can be blanched to destroy undesirable storage limiting enzymes and/or to enhance the texture of the carrots.

The blanched carrots can then be sliced and quick frozen from methods known in the art. At a designated time, the frozen carrots can be thawed to about 45° F. (7° C.) in an atmospheric tub. Hot water (100° F.-120° F.) (37° C.-49° C.) can be circulated in the bottom jacket of the tub for 30 to 45 minutes and the products can be mixed every 5 minutes with hot water until the product reached the desired temperature. Other thawing methods are well known in the art.

Separate from the processing step 210, the infusion solution is prepared 220. In another embodiment, steps 210 and 220 may be combined simultaneously, thawing out IQF products by soaking them in the infusion solution maintained between approximately 40° F. to 55° F., and more preferably 45° F. to 50° F. As used herein, an infusion solution means an effective amount of calcium ascorbate such that the food comprises between about 0.2% and about 0.3% of calcium ascorbate by weight of the food upon exiting the solution. It is recognized that multiple infusion steps may be used and different time, temperature, pressure, and concentration relationships can be used to achieve a food product having the desired concentration of calcium ascorbate. All such relationships are construed to be encompassed within the claims scope of the present invention. In one embodiment, the infusion solution comprises between about 0.5% and about 1.5% of calcium ascorbate by volume of the solution.

Thereafter, the prepped food products are combined with the infusion solution 230 in any convenient manner. Sufficient amounts of the infusion solution are combined such that the admixed food products are completely immersed in the infusion solution. Complete immersion is desired to ensure that sufficient contact is maintained between the products and the infusion solution. The infusion solution temperature should be at temperatures between 40° F. to 55° F., and more preferably 45° F. to 50° F. to avoid microbial growth.

In one embodiment, the infusion solution has an initial Brix concentration of about 40° to about 50°, preferably about 45°, as measured on the Brix scale. The Brix scale refers to a hydrometer scale used for sugar solutions that is graduated so its readings in degrees represent percentages by weight of sugar or solids in a solution at a specified temperature. Thus, Brix refers to a concentration of sugar or solids in a solution by weight. The initial Brix of the food product depends on the type of fruit or vegetable to be used, but they are typically less than about 16° Brix. The solution can be maintained at a concentration of between about 30° to about 60° Brix.

In one embodiment, the food products are first infused at atmospheric pressure 140, approximately 760 torr (1 atm), for 30 minutes to 60 minutes. The times will vary depending on the specific product and the desired end product attributes. Upon immersion in the infusion solution, the product begins to take in calcium ascorbate. Infusion process conditions are typically driven by the physical properties of the fruit or vegetable piece being infused, such as the dimensions and uniformity of the food product, and the finished product quality desired, such as texture, flavor, appearance, and oil content.

After the infusion phase at atmospheric pressure, the food products, in one embodiment, will undergo vacuum infusion 250. It is preferred to subject the products to reduced pressure after a period of atmospheric infusion to allow the pieces to build the structural calcium bridges between neighboring pectin molecules and prevent damage to the products' cell walls when the vacuum is applied. When used in conjunction, the atmospheric and vacuum infusion methods maximize the efficiency of the infusion process. Vacuum infusion helps accelerate the mass transfer of solids into the product and significantly reduces the time required for infusion compared to atmospheric infusion. It also tends to maintain the shape of a product better, especially when combined with vacuum frying in the final stage. It is desirable to be able to conduct both infusion methods, either in conjunction or alone, within a single apparatus and customize the times to be used for each method and pressure levels for the vacuum infusion period to achieve the desired product characteristics. In an alternative embodiment, the vacuum infusion step 250 is not used.

Upon depressurization (vacuum creation), gas and moisture contained between the cell walls of the product is evacuated. When the vacuum is released, re-pressurization causes the infusion solution and thus its inherent solids to be forced into the spaces previously occupied by gas. In one embodiment of the invention, pulses of vacuum are used to further accelerate the solute intake. A pulse of vacuum comprises depressurizing the apparatus for a short period of time and then re-pressurizing. Each of these cycles of depressurization (vacuum) and pressurization promote more efficient infusion, resulting in less infusion time.

The number of cycles and how long each product spends at the lower or elevated pressure is product dependent. Some products only require one cycle, while with other products it is desirable to have multiple cycles of depressurization and pressurization. In one embodiment, each pulse of vacuum is typically maintained for 2 to 5 minutes and applying at least one to two pulses of vacuum results in the most efficient product infusion. For example, in IQF carrots, the depressurization (vacuum) phase lasts from about 1 to 3 minutes, more preferably about 2 minutes.

In one embodiment, the subsequent re-pressurization lasts approximately 4 to 6 minutes, and more preferably 5 minutes, followed by subsequent depressurization from about 1 to 3 minutes, more preferably about 2 minutes. In one embodiment, an IQF carrot is infused in three phases—first at atmospheric pressure for 50 to 70 minutes, preferably 60 minutes, then under vacuum (depressurized) for about 1 to 3 minutes, more preferably about 2 minutes, then concluded by a second atmospheric pressure phase for approximately 40 to 50 minutes, and more preferably 45 minutes.

In one embodiment, vacuum infusion 50 is carried out by subjecting the products in the infusion solution to reduced pressure (partial vacuum) of about 200 torr to about 600 ton, as needed and customized for the product being infused for a period of up to ten minutes. For thawed carrot slices, it is preferred that the depressurization (vacuum) pressure range from about 200 ton to about 400 ton. Such pressure ranges are, however, provided for the purpose of illustration and are not limitations. The residence time and pressures involved in the vacuum pulses can vary significantly depending on the product and desired end product.

The product then undergoes vacuum frying 270 to a moisture content of less than about 3% and more preferably less than about 2% by weight or other desired moisture content. In one embodiment, the food material is deep-fried in oil at a temperature much lower than conventional frying methods. In a one embodiment, the product is fried at temperatures ranging between approximately 250° F. (121° C.) and 270° F. (132° C.) for approximately 10 to 50 minutes, with steam being supplied for about the initial 1 to 5 minutes so that the temperature of the frying oil can be maintained at a desired level such that the high moisture fruit or vegetable material being fried can be dehydrated effectively. Frying can occur at a pressure of approximately 10 to 40 ton at different initial temperatures depending on the product in order to avoid browning. For carrots, the temperature is between approximately 230° F. and 270° F., and more preferably 250° F. at a pressure between 20 and 40 torr, and more preferably 30 ton, with about 3 minutes of steam, for between approximately 20 to 30 minutes frying time, and more preferably 25 minutes, following by a drain time of about 3 minutes.

In an optional seasoning step, the products then undergo seasoning by any means known in the art such as application of a seasoning spray, powder, or slurry. The products are then packaged 280 for consumer consumption.

During the dehydration that occurs during drying of the carrot pomace discussed above with reference to FIG. 1, the wet carrot pomace is susceptible to oxygen from exposure to heated air, in the drying process, and during storage. During deep frying, on the other hand, there is a relatively low level of oxygen in frying oil. Any oxygen originally dissolved in unheated frying oil is consumed by oxidation in the time taken to heat the frying oil to frying temperatures. Additional oxygen that can enter the frying oil is by diffusion from the air which can be prevented or minimized by the fryer design. During deep frying in hot oil, the carotenoids react through co-oxidation with the fatty acids in the hot oil. Consequently, the carotenoids can be decomposed by reacting with oxidized fatty acids. The more unsaturated the frying oil, the more rapid the destruction of carotenoids under frying conditions and during subsequent storage due to the co-oxidation of fatty acids and carotenoids.

Because the concentration of free lipidic radicals is high in frying oils, the reaction between two lipidic free radicals occurs fairly easily. Further, the concentration of non-oxidizing lipidic free radicals increases because of the lack of oxygen and the possibility of their interaction with one another or with an anti-oxidant free radical such as a carotenoid increases. However, it has been surprisingly discovered that when the calcium ascorbate is added to a food product prior to frying, there is much greater stability against oxidation in accelerated shelf-life testing as exemplified by the Example below. The following Example describes particular steps, conditions, and materials according to this invention, but it is to be understood that this example is submitted by way of illustration, and not limitation.

Three samples of cut and blanched IQF carrots were thawed. A sugar solution was prepared comprising high maltose corn syrup having an initial Brix concentration of 45°. The sugar solution was divided into three portions. No additional ingredients were added to the first solution—a control solution. About 100 g ascorbic acid was added to 10 L (e.g., about 10 kg) of the second solution to make an ascorbic acid solution. About 100 g of calcium ascorbate was added to 10 L (e.g., about 10 kg) of the third solution to make a calcium ascorbate solution. The solution was at room temperature and carrots were then soaked in each solution for 10 minutes. The slices were then drained for 5 minutes. Next the infused carrot slices were vacuum fried in hot oil at a temperature of 120° C. at a pressure of 100 kPa to a moisture content of between about 1.0 to about 1.5% by weight. The fried slices were then placed into an oven that was held at 60° C. for a period of seven days for accelerated shelf life testing.

Rancidity may be determined easily by taste or odor, or both taste and odor, or by using standard means, e.g., gas chromatography, to determine the amount of hexanal produced, e.g., by lipid oxidation, in either the headspace of the vacuum fried food or in the food itself. Hexanal accumulates linearly until a certain time, known as the time of break point, wherein the rate of accumulation begins to deviate from linearity and increase exponentially. The break point of rapid hexanal accumulation is close to the time when consumers begin to detect rancidity. At various times within the seven day period, the vacuum fried carrot slices were tested for hexanal levels since hexanal is an indication of rancidity.

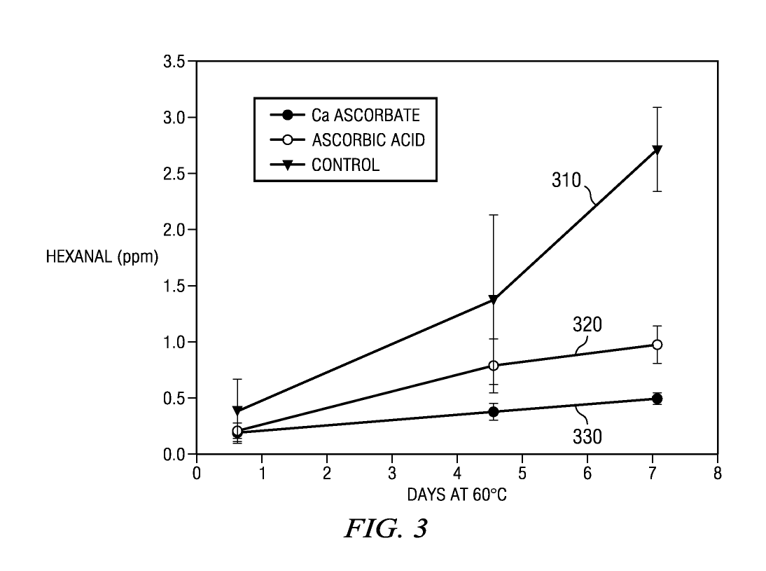

FIG. 3 depicts a chart comparing the hexanal concentrations of various treated and untreated vacuum fried carrot chips in accordance with one embodiment of the present invention. The control sample 310 has an exponential rate of hexanal with time. The ascorbic acid treated 320 carrot slices have less hexanal but the calcium ascorbate treated 330 carrot slices have a much lower rate of hexanal production. Consequently, the finished food product that has been treated with an infusion of calcium ascorbate will have a greater shelf life than both the untreated and ascorbic acid treated carrot slices as exemplified by FIG. 3.

While the invention has been particularly shown and described with reference to a preferred embodiment, it will be understood by those skilled in the art that various changes in form and detail may be made therein without departing from the spirit and scope of the invention. For example, while the invention has been particularly shown and described with reference to several carrot embodiments, it will be understood by those skilled in the art that the reduction of oxidation in thermally processed foods by use of calcium ascorbate can be made with various other foods rich in carotenoids, such as beta carotene, and in foods having other desirable unsaturated fatty acids, without departing from the spirit and scope of this invention.

Notably, the addition of calcium ascorbate is different from adding vitamin C and another calcium source such as calcium chloride because the addition of the same level of vitamin C results in a lower pH and provides an acidic, tart taste. Calcium chloride gives a bitter taste. While calcium chloride and ascorbic acid have been used as anti-browning agents in foods subject to enzymatic browning, which are identified in Table 1 as those foods having an asterisk (*), calcium ascorbate has not been recognized for its ability to preserve carotenoids in non-enzymatic browning foods that are dried and made into dehydrated food ingredients, such as dehydrated carrot pomace and dehydrated food products such as fried carrot pieces. As used herein, foods subject to enzymatic browning or “enzymatic browning foods” are defined as any plant-based food that after being cut in cross-section visibly browns after being exposed to ambient conditions (e.g., 70° F. in open air) for less than about 2 hours and examples of such foods are identified by an asterisk in Table 1 below. As used herein, a non-enzymatic browning food is defined as any plant-based food that does not visibly brown after being exposed to ambient conditions for more than about 2 hours and more preferably more than about 4 hours and most preferably more than about 6 hours.

As is well known in the art, polyphenol oxidase (“PPO”) is the generic term for a group of enzymes that, if present in high enough concentration, causes undesirable browning in some foods. Foods having such contents are referred to herein as “enzymatic browning foods” and include apples, apricots, avocados, bananas, cacao, coffee beans, egg plant, grape (not grape leaves), lettuce, lobster, mango, mushroom, peaches, pears, plums, potato, shrimp, sweet potato, and tea. However, anti-browning agents are not typically used on foods that do not brown.

The Table below lists mean beta carotene concentrations, in parts per million by weight of various foods.

TABLE 1
β-carotene content of various foods. Taken from Journal
of Food Composition and Analysis 12, 169-196, “Carotenoid
Content of U.S. Foods: An update of the Database,” Article
No. jfca. 1999.0827, available online at www.idealibrary.com

| | Beta Carotene |
|---|---|
| Food | (ppm) |
| Apples, raw, with skin* | 66.4 |
| Apricots, raw* | 25.5 |
| Avocado, raw, all commercial varieties* | 0.53 |
| Bananas, raw* | 0.21 |
| Beet greens, raw | 34.1 |
| Carrots, A-plus cultivar, cooked | 256.5 |
| Carrots, A-plus cultivar, raw | 182.5 |
| Carrots, baby, raw | 72.7 |
| Carrots, dehydrated | 689.2 |
| Carrots, frozen, cooked, boiled, drained, without salt | 122.7 |
| Carrots, raw | 88.4 |
| Chard, swiss, raw | 39.5 |
| Cilantro, raw | 34.4 |
| Collards, cooked, boiled, drained, without salt | 44.2 |
| Collards, frozen, chopped, unprepared | 55.1 |
| Collards, raw | 33.2 |
| Grape leaves, raw | 161.2 |
| Grapes, red or green (European types, varieties, such | 0.39 |
| as Thompson seedless), raw* | |
| Lettuce, cos or romaine, raw* | 12.72 |
| Lettuce, iceberg (includes crisphead types), raw* | 1.92 |
| Kale, cooked, boiled, drained, without salt | 62.0 |
| Kale, raw | 92.3 |
| Mangos, canned, drained* | 131.2 |
| Mushrooms, black, dried* | 0 |
| Mushrooms, straw, canned, drained solids* | 0 |
| Peaches, canned, heavy syrup, drained* | 3.34 |
| Peaches, raw* | 0.97 |
| Pears, canned, heavy syrup, drained* | 0.04 |
| Pear, raw* | 0.27 |
| Peppers, sweet, red, cooked boiled drained, without | 22.2 |
| salt | |
| Peppers, sweet, red, raw | 23.8 |
| Plums, raw* | 0.98 |
| Potato, raw, flesh and skin* | 0.06 |
| Pumpkin, canned, without salt | 69.4 |
| Spearmint, dried | 88.5 |
| Sprearmint, fresh | 21.3 |
| Spinach, cooked, boiled, drained, without salt | 52.4 |
| Spinach, canned, drained solids | 48.2 |
| Spinach, frozen, chopped or leaf, unprepared | 49.4 |
| Spinach, raw | 56.0 |
| Squash, winter, butternut, raw | 42.3 |
| Sweetpotato, cooked, baked in skin, without salt* | 94.9 |
| Sweetpotato, raw* | 91.8 |
| Turnip greens, cooked, boiled, drained, without salt | 45.8 |

*Indicates an enzymatic browning food as defined in this specification.

While the process has been specifically disclosed with regard primarily to carrot products, the process can also be used in processing of one or more of the raw food ingredients having elevated levels of carotene (e.g., levels exceeding 20 ppm) that are not an enzymatic browning food. In one embodiment, the present invention is directed towards non-enzymatic browning foods having a beta carotene content of at least 20 ppm. Consequently, the process described herein can be applied to raw foods including, but not limited to, beet greens, carrots, chard, cilantro, collards, grape leaves, kale, peppers, pumpkin, spearmint, spinach, squash, and turnip greens. In one embodiment, the non-enzymatic browning food comprises an individually quick frozen food product.

Interestingly, Table 1 reveals that very few food ingredients having elevated levels of beta carotene (e.g., levels exceeding 20 ppm) are also enzymatic browning foods. The only enzymatic food ingredients listed in Table 1 as having elevated levels of beta carotene are apples, apricots, mangos, and sweet potatoes. However, because the addition of calcium ascorbate is different from adding vitamin C and another calcium source such as calcium chloride, in one embodiment, the process described herein can be applied to enzymatic browning foods having elevated levels of beta carotene including, but not limited to apples, apricots, mangos, and sweet potatoes.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

What is claimed is:

1. A method of preparing a low moisture food having carotenoids, said method comprising the steps of:
a. providing a non-enzymatic browning food having a native carotenoid concentration of at least about 20 ppm;
b. adding calcium ascorbate to said food wherein said food comprises at least about 0.1% by weight of calcium ascorbate after said addition; and
c. dehydrating said food to a moisture content of less than about 15% by weight.

2. The method of claim 1, wherein said food comprises carrot pomace.

3. The method of claim 1, wherein said food comprises spinach.

4. The method of claim 1, wherein said food comprises tomato.

5. The method of claim 1, wherein said food comprises carrot.

6. The method of claim 1, wherein said carotenoid comprises lycopene.

7. The method of claim 1, wherein said carotenoid comprises beta carotene.

8. The method of claim 1, wherein said carotenoid comprises alpha carotene.

9. The method of claim 1, wherein said adding of said calcium ascorbate at step b) comprises soaking said food in a solution comprising calcium ascorbate.

10. The method of claim 1, wherein said calcium ascorbate is added to said food.

11. The method of claim 1, wherein said dehydrating at step c) is to a moisture content of less than about 3% by weight.

12. The method of claim 11, wherein said dehydrating at step c) occurs by frying said food in hot oil.

13. The method of claim 1, wherein said dehydrating of said food in step c) comprises oven drying.

14. The method of claim 1, wherein said food in step a) comprises one or more non-enzymatic foods selected from beet greens, chard, cilantro, collards, grape leaves, kale, peppers, pumpkin, spearmint, spinach, squash, and turnip greens.

15. A method for preparing a vacuum fried food, said method comprising the steps of:
a. providing an individually quick frozen non-enzymatic browning food having a native carotenoid concentration of at least about 20 ppm;
b. placing said individually quick frozen non-enzymatic browning food into an infusion solution comprising between about 0.5% and about 1.5% of calcium ascorbate by volume of said solution to make an infused food having a calcium ascorbate concentration of between about 0.2% and about 0.3% by weight of said infused food; and
c. vacuum frying said infused food to a moisture content of less than about 3% by weight.

16. The method of claim 15, further comprising the step of wherein said infusion solution comprises a Brix concentration of between about 30° to about 60° Brix.

17. The method of claim 15, wherein said food comprises carrot.

18. A method for preparing a low moisture food having carotenoids, said method comprising the steps of:
a. providing a non-enzymatic browning food having a native carotenoid concentration of at least about 20 ppm;
b. adding calcium ascorbate to said food wherein said food comprises at least about 0.1% by weight of calcium ascorbate after said addition;
c. dehydrating said food to a moisture content of less than about 15% by weight.

19. The method of claim 18 wherein said non-enzymatic browning food comprises carrot.

20. The method of claim 18 wherein said non-enzymatic browning food comprises carrot pomace.
